(19) United States
(12) Patent Application Publication
(10) Pub. No.: US 2005/0093647 A1
(43) Pub. Date: May 5, 2005

(54) Twinned pseudo-elliptic directional filter method and apparatus

(76) Inventors: William A. DeCormier, Poland, ME (US); Jeffrey M. Brown, Windham, ME (US)

Correspondence Address: BAKER & HOSTETLER LLP;Washington Square, Suite 1100, 1050 Connecticut Avenue, N.W., Washingtion, DC, 20036, US

(21) Appl. No.: 10/697,643

(22) Filed: Oct. 31, 2003

(51) Int. Cl. H01P 1/213

(52) U.S. Cl. 333/110; 333/212

(57) ABSTRACT

A directional filter and/or combiner for high-power RF signals provides optimized power handling and allows cascading of waveguide filter elements. The use of circular filter cavities allows the filter to have pseudoelliptic coefficients while ensuring phase stability and maximizing power handling.

### FIELD OF THE INVENTION

The present invention relates generally to radio frequency electromagnetic wave (RF) transmission equipment. More particularly, the present invention relates to an apparatus and method for filtering and combining RF signals using directional elliptic filters.

### BACKGROUND OF THE INVENTION

High-voltage, high-power RF signals, as employed for example in the field of broadcasting for communication and entertainment, are commonly coupled from transmitters to coaxial or waveguide signal lines and carried by the signal lines to transmitting antennas. After a transmitter and before a transmission line, a system can include a device known as a directional filter, which uses its filter properties to facilitate the combining of RF signals onto a single waveguide.

An example of a situation that calls for high performance directional filters is the need for a transmitter system to carry multiple broadcast channels on a single waveguide system. Such a system is desirable to feed several single-channel antennas or one or more broadband antennas located on a tower for which minimized wind loading is desirable, and for which therefore the smallest practical number of transmission lines carrying signals up the tower is desirable.

A solution to this need may include feeding a single transmission line with several broadcast channels. These broadcast channels may be close together in frequency, possibly separated by one or even no unused channels. A system including multiple directional filters and/or combiners (DFCs) can be used at each end of a transmission line, both to add RF signals to the waveguide at the transmitter end without allowing off-frequency RF energy present therein to damage the individual RF sources, and, if applicable, to separate out the individual RF signals at the antenna end of the transmission line and direct those signals to individual antennas for which the signals are intended. The separating-out function may not be relevant in systems employing broadband antennas. The transmission line or lines used may be of any type or combination of types as dictated by requirements, of which types the most common are coaxial lines made from inner and outer copper tubes and waveguide made from aluminum sheet.

Some aspects of directional filter technology are familiar to those knowledgeable in the art. One well-known directional filter design, presented in some detail in “Directional Channel Separation Filters,” Cohn, S. B., and F. S. Coale, Proceedings of the IRE, August, 1956, pp. 1018-1024, and shown as well in Microwave Filters, Impedance-Matching Networks, and Coupling Structures, Matthaei, Young, and Jones, McGraw-Hill Book Co., 1964, p. 847, uses a section of circular waveguide for the filter that connects a lower rectangular waveguide to an upper rectangular waveguide. The circular waveguide is partitioned into cascaded cavities termed resonators by a series of baffles pierced by apertures, which apertures are also referred to in the art as irises. In the circular waveguide element of the DFC shown in Matthaei et al, the number and size of the resonators, diameter of the apertures, thickness of the baffles, and other dimensions define filter properties, including number of poles and coupling coefficients, so that a single filter assembly could be configured as an n-pole Chebyschev or an n-pole Butterworth, for example, depending on fabrication details.

Matthaei et al describes using a system with input and output rectangular waveguides and circular filter sections for microwave applications. Adapting the concept for use in broadcasting at high power in the Ultra-High Frequency (UHF) band can cause the physical size to grow tenfold or more, as does the size of the gap for dielectric breakdown and thus the maximum power capacity.

Cohn et al describe both the use of circular waveguide with circularly polarized propagation and the use of dual rectangular waveguides for feed, with coupling irises separated by one or two half wavelengths of center frequency to capture all of the in-band input energy.

Elliptic filters have intrinsic advantages compared to some other filter types, particularly for applications in which physical size may need to be traded off against filter performance. Elliptic filters exhibit a solid balance between out-of-band rolloff and passband uniformity for a minimized number of poles.

Accordingly, there is a need in the art for a directional filter and/or combiner that overcomes, at least to some extent, the problems associated with other waveguide filter and/or combiner designs, and provides cascadable directional filter and combiner properties.

### SUMMARY OF THE INVENTION

Preferred embodiments of the invention provide cascadable directional filter and combiner features. In some embodiments, the directional filter and/or combiner (hereinafter a DFC) provides directional signal combining for RF signals using a bandpass filter comprised of a pair of rectangular waveguides coupled by elliptic bandpass filters. RF power directed to the DFC enters by one of four substantially identical ports arranged similarly to those in other types of waveguide combiners. In-band RF output from the DFC exits at another port distal to the input, having passed through a bandpass filter. The other two ports of the DFC are isolated.

In a first aspect, a DFC comprises two sections of waveguide, with a first portal waveguide section carrying an input directly to a band-reject output, and a second portal waveguide section connecting an out-of-band feed to an output shared between the out-of-band feed and a band-passed signal. The two sections of waveguide are connected by one or more filters, which filters are further comprised of waveguide entry and exit sections connected by circular waveguide sections capable of implementing elliptic bandpass filters.

The internal structures used to implement the elliptic bandpass filters may include ports of specified sizes at specified locations and baffles with apertures to define resonant cavities and provide coupling between the resonant cavities. Satisfactory emulation of elliptic filter characteristics can be achieved with fewer than the classic number of zeros, that is, with a limited number of zeros at finite frequencies leaving the remainder of zeros at infinity. Hence the present invention bears the name pseudo-elliptic in its title, although the term elliptic is used throughout for brevity.

In another aspect, a waveguide DFC for filtering and combining radio frequency signals (RF) comprises a first rectangular waveguide section; a first elliptic waveguide filter section, affixed to the first rectangular waveguide section at a substantially perpendicular angle, with a common electrical-signal axis thereto; a second elliptic waveguide filter section, affixed to the first rectangular waveguide section at a substantially perpendicular angle thereto and substantially parallel to the first rectangular waveguide filter section; and a second rectangular waveguide section affixed to and terminating the first and second elliptic waveguide filter sections.

In still another aspect, a DFC capable of operation at broadcast power levels comprises means for guiding an RF broadcast signal along a path with a conductive boundary, along which path the signal can propagate; first means for directing a component of the RF broadcast signal at a specific frequency and a specific phase orientation along a path at right angles to the first conductively-bound path; means for guiding the remnant RF broadcast signal further along the initial path; second means for directing an RF broadcast signal component at the same frequency as but out of phase with respect to the RF broadcast signal component directed by the first means for directing, where the second means for directing directs the RF signal component that was out of phase with respect to and unable to propagate along the first conductively-bound path; means for guiding the out-of-band energy of the RF broadcast signal along a further path out of the apparatus; means for rejoining the specific RF broadcast signal components back together in their original phase relationship; and means for guiding the rejoined RF broadcast signal components along a further path out of the apparatus.

In yet another aspect, a method for filtering, combining, and separating RF signals is comprised of the steps of admitting an RF broadcast signal into a first portal waveguide component of an elliptic filter waveguide DFC; propagating the RF signal along a first portal waveguide; admitting any in-band RF signal energy from the RF broadcast signal into a first filter comprising the DFC; further propagating the RF signal along a continuation of the first portal waveguide for a distance approximating an odd number of quarter wavelengths of the in-band component of the RF signal; admitting from the RF broadcast signal into a second filter within the DFC, functionally out of phase with respect to the first filter, any in-band RF signal energy out of phase with respect to the RF signal energy admitted into the first filter; passing any RF broadcast signal energy admitted into neither filter out the end of the first portal waveguide; collecting the RF signal energy passed through both filters into a second portal waveguide with a geometry that restores the original phase relation of the signal components; and passing the recombined RF signal energy out of the DFC out the end of the second portal waveguide.

An elliptic filter waveguide DFC, externally configured similarly to a classic single circular waveguide DFC, scaled up to the size needed for UHF broadcasting, can intrinsically support higher power and can potentially increase the number of channels that can be combined, the range at which a signal can be received, the practical height of a transmission tower, and other considerations, while maintaining RF performance comparable or superior to that of a corresponding DFC based on other filter types. An elliptic filter DFC scaled not for UHF television broadcasting but for functions such as business communications in frequency bands in the vicinity of UHF may exhibit comparable benefits of ease of frequency control and improved power handling.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. It is also to be understood that the phraseology and terminology employed herein, as well as the abstract, are for the purpose of description, and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an oblique view illustrating a representative twinned cylindrical waveguide DFC for broadcast signals.

FIG. 2 is a phantom view of the twinned cylindrical waveguide DFC showing the internal construction that establishes the filter characteristics of the device.

FIG. 3 is a functional block diagram representation of a DFC device.

FIG. 4 is a functional block diagram of a multiplicity of blocks from the diagram of FIG. 3 showing their interconnection in a signal combiner.

FIG. 5 is a functional block diagram of a multiplicity of blocks from the diagram of FIG. 3 showing their interconnection in a signal separator.

FIG. 6 is a simplified physical representation of a single DFC device.

FIG. 7 depicts the device of FIG. 6 with two different frequencies applied, one in-band and the other out-of-band.

FIG. 8 depicts the device of FIG. 6 with two in-band signals applied.

FIG. 9 depicts the device of FIG. 6 with two out-of-band frequencies applied.

FIG. 10 is a simplified physical representation of a single DFC device according to an alternative embodiment.

### DETAILED DESCRIPTION OF THE INVENTION

A preferred embodiment of the invention provides cascadable cylindrical waveguide directional filter and combiner functions. In some embodiments, the directional filter and/or combiner (hereinafter a DFC) provides directional signal combining for RF signals using elliptic bandpass filter sections comprised of combinations of rectangular and circular waveguide sections. RF power directed to the DFC enters by one of four substantially identical ports arranged similarly to those in other types of waveguide combiners. In-band RF output from the DFC exits either at the distal port on the opposite waveguide, or at the proximal port on the opposite waveguide, depending on key details of the implementation, having in either case passed through one or the other elliptic bandpass filter. The other two ports of the DFC are isolated.

A waveguide DFC needs to fall within a specific size range in order to operate efficiently for a given frequency or group of frequencies. Standard applications for UHF broadcast power levels, for example, commonly use sizes of waveguide chosen to either to carry the portion of the UHF spectrum needed for a multiple channel system, or to prevent propagation of signals at frequencies to be excluded from a particular application. Frequency regimes other than UHF likewise use a variety of sizes of waveguide. Each size has voltage and conductivity limits that tend to limit power, although in general lower frequencies afford higher voltage breakdown thanks to larger physical size, and higher current handling thanks to both larger surfaces to conduct current and deeper penetration regarding skin depth.

Preferred embodiments of the invention will now be described with reference to the drawing figures, in which like reference numbers refer to like elements throughout. For reference purposes, the assumed orientation of the physical DFC, as distinct from the schematic DFC, will refer to “up”, “down”, “left”, and “right” from the viewer's viewpoint with respect to the drawings. However, when installed, the components may actually be in any spatial orientation.

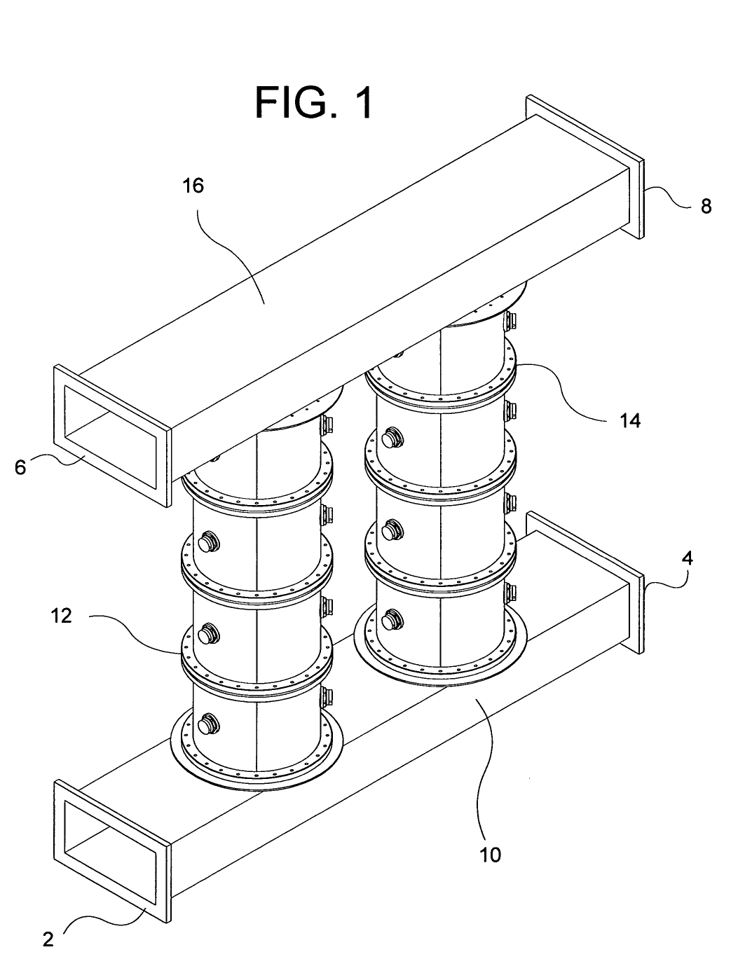

FIG. 1 illustrates an arrangement where in-band RF entering at a first flange 2 propagates rightward along a first portal waveguide 10, up through a first filter waveguide 12 or a second filter waveguide 14, to the right along a second portal waveguide 16, and out through a fourth flange 8. Where the DFC is intended to conform to the requirements and guidelines of the Electrical Industry Association (EIA), and other advisory organizations, the expected dimensions for a DFC incorporating the invention may be by preference in the ratio of roughly 2:1, with the long axis sized for TE₁₀, termed the dominant mode, propagation. This guideline provides high confidence that propagation in other modes will be prevented. For other applications, the properties of a 2:1 aspect ratio may be undesirable, with ratios such as 3:1 or 4:1 affording improved performance; in all cases, the dimension along at least one axis must be large enough to be above cutoff for all frequencies carried in the waveguide, to permit propagation.

Rectangular waveguide intended to be limited to operation in the TE₁₀ mode, which can be assured with the wider axis of the cavity significantly exceeding the narrower axis, and with the narrower axis smaller than the wavelength of the highest-frequency RF to be introduced, can readily sustain electric-field propagation parallel to the wider axis only. This may provide the benefit that minor defects and damage to the waveguide, while they may introduce low-level reflections and other distortions, will not generally cause the field orientation to shift substantially.

The term “flange” as used herein may refer to a fastening system for providing electrical, mechanical, and environmental support, alignment, and/or sealing as needed, which system may employ, for example, bolts, guide pins, and/or other clamping and alignment devices on a partial or complete external perimeter lip that may be orthogonal to the propagation axis of a waveguide section at each end thereof. The fastening system may further employ an O-ring recessed in a groove in one or both of a mated flange pair at a joint, as well as such other attaching provisions as may be needed to perform electromechanical and environmental assembly of waveguide-based components to each other. Flanges may also serve as attachment points between waveguide-based components and external mounting apparatus. Flanges may be pierced at intervals for installation of fasteners, alignment pins, hangers, and other fittings.

From a functional viewpoint, a flange can serve as the entry point or portal through which incoming RF passes in order to enter the DFC. Each waveguide component of the DFC, whether equipped with filtering components or not, preferably functions as a pathway for the propagation of RF within the DFC.

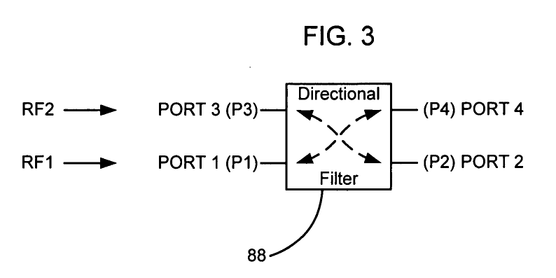

The apparatus of FIG. 1 can be represented, as illustrated in FIG. 3, by a standard schematic block 88, which is commonly used in the art to represent a DFC, and in which the ports 2, 4, 6, and 8 of FIG. 1 are represented functionally in FIG. 3 as ports P1, P2, P3, and P4, respectively.

A DFC may allow RF energy over a broad range—the equivalent of several television channels—to pass from an input port, such as P1 in FIG. 3, to a rejected-signal output port, such as P2 in FIG. 3, while RF energy from only a narrow range—such as a single television channel with a passband on the order of 8 MHz—is admitted, or allowed to pass from that input port P1 to an in-band output port, P4 in FIG. 3.

The foregoing property of admitting RF is represented by the dashed arrows in FIG. 3, which emphasize that in-band RF from P1 can pass through to P4 or vice versa, as well as from P2 to P3 and vice versa. All of these pathways are equivalent and interchangeable for in-band RF. Out-of-band RF, rejected by the DFC, passes from P1 to P2 and vice versa, as well as from P3 to P4 and vice versa. There is typically not a mechanism to permit in-band RF to pass between P1 and P3, between P1 and P2, between P2 and P4, or between P3 and P4 in the devices shown in FIG. 3.

As an example, a first RF signal, RF1, can be applied to input port P1 of the DFC, shown in FIG. 3. If it contains only in-band RF, then all of RF1 will pass out through P4. Similarly, if a second RF signal, RF2, also containing only in-band RF, is applied to P3 of the DFC, then all of RF2 will pass out through P2. If RF2 contains instead only out-of-band RF, then all of RF2 will instead pass out through P4, which is the same port out which the in-band RF energy of RF1 will pass.

FIG. 1 illustrates an external view of a preferred embodiment of a DFC 1, showing a first flange 2, a second flange 4, a third flange 6, and a fourth flange 8. The first flange 2 may be associated with P1 of the schematic block of FIG. 3; then, continuing the example above for this physical model, RF1 can propagate along a first portal waveguide 10.

Any RF energy of RF1 that is in the channel frequency to which the DFC is tuned—and which has a referenced instantaneous phase orientation—may propagate preferentially upward through a first filter 12. Any energy remaining in signal RF1 may continue to propagate to the right along the first portal waveguide 10. If the frequency and phase of the remaining energy are correct with respect to the reference, that is, of the same channel as the RF admitted into the first filter 12 but out of phase with respect to the admission phase therefor at the time of passing the first filter 12, the remaining energy propagates through a second filter 14, positioned an odd number of quarter wavelengths, such as 270 degrees of phase, further along the first portal waveguide 10 and oriented parallel to the first filter 12.

Any RF energy in RF1 not admitted into either the first filter 12 or the second filter 14 is by definition out of the passband of the filters comprising the DFC. This out-of-band energy continues to propagate to the end of first portal waveguide 10, exiting at the second flange 4, where it can be absorbed and dissipated as heat or used for functions such as signal separation. As noted in the discussion of FIG. 3, port P2 is the exit port for out-of-band RF entering at P1; therefore, it can be seen that the second flange 4 in the physical representation corresponds to P2 in the schematic block of FIG. 3.

Because of the symmetry of the design, the same logic applies regardless of which of the four flanges serves as P1, P2, P3, or P4, provided the flow paths of FIG. 3 are physically present. As shown in FIG. 3, in-band RF introduced on P1 comes out substantially unchanged on P4, and in-band RF introduced on P4 comes out substantially unchanged on P1. By the same process, in-band RF introduced on P2 comes out substantially unchanged on P3, and in-band RF introduced on P3 comes out substantially unchanged on P2. For out-of-band energy, the reverse applies: the dotted-line paths of FIG. 3 are not available. This results in out-of-band RF introduced on PI coming out substantially unchanged on P2, and out-of-band RF introduced on P2 coming out substantially unchanged on P1. Likewise, out-of-band RF introduced on P4 comes out substantially unchanged on P3, and out-of-band RF introduced on P3 comes out substantially unchanged on P4. Thus, rotating the directional filter symbol of FIG. 3, or the physical DFC of FIG. 1, about its vertical axis or its horizontal axis produces unchanged functionality.

Assigning a nominal zero degree phase to the signal as it enters the first elliptic filter waveguide 12, and a 270 degree phase to the signal as it enters the second elliptic filter waveguide 14 in the first embodiment shown, the two subsets of the input energy that are passed by the two elliptic filter waveguides are out of phase. The distances traveled up the two equal-length elliptic filter waveguides may in some embodiments be ignored for phase analysis, assigning the same phase relationship at the top as at the bottom. Energy propagating from the exit of the first filter waveguide toward the exit of the second can in those case acquire the same phase shift previously acquired by the energy that propagated up the second, namely 270 degrees, so that the two signals are restored to their original phase relationship, that is, they reinforce, as they propagate to the right and exit the filter at the fourth flange 8. Energy exiting from the second filter waveguide and propagating back toward the first, on the other hand, may acquire an additional 270 degree phase shift, for a total of 360 degrees plus 180 degrees, which means that it cancels, in which cases the propagation of the signal out the third flange 6 is blocked.

The other permutations of the FIG. 3 discussion also apply to the physical realization of FIG. 1. Thus, injecting an out-of-band signal RF2 into P3 may result in no energy passing down through first and second filters 12 and 14, all of RF2 instead passing out P4.

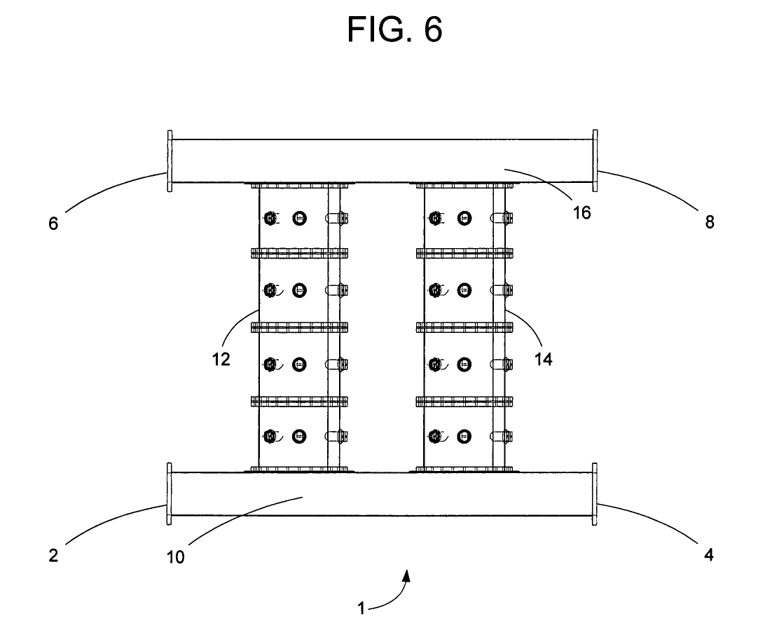

The port P3 at the third flange 6 as shown in FIG. 6, if fed with a second signal at a second frequency outside the filter passband, will in some embodiments have the second signal rejected by the first filter 12 and the second filter 14; this second signal will then propagate directly along its input waveguide 16, to exit the DFC at port P4 at the fourth flange 8 along with any in-band signal coupled across from the first signal's input at port P1 at the first flange 2. The signals so injected into a system are unrelated to each other and do not interact significantly provided randomly summing voltage peaks do not exceed the breakdown limit for the air dielectric within the DFC. The same process, namely injecting in-band and out-of-band RF signals into two ports of a DFC, then extracting the combined signal for injection into the next DFC, can be used an arbitrary number of times to inject signals at multiple frequencies into a single waveguide. With DFC filter designs that achieve a sufficiently sharp cutoff, losses due to passing through filter sections that operate at other frequencies may be negligible.

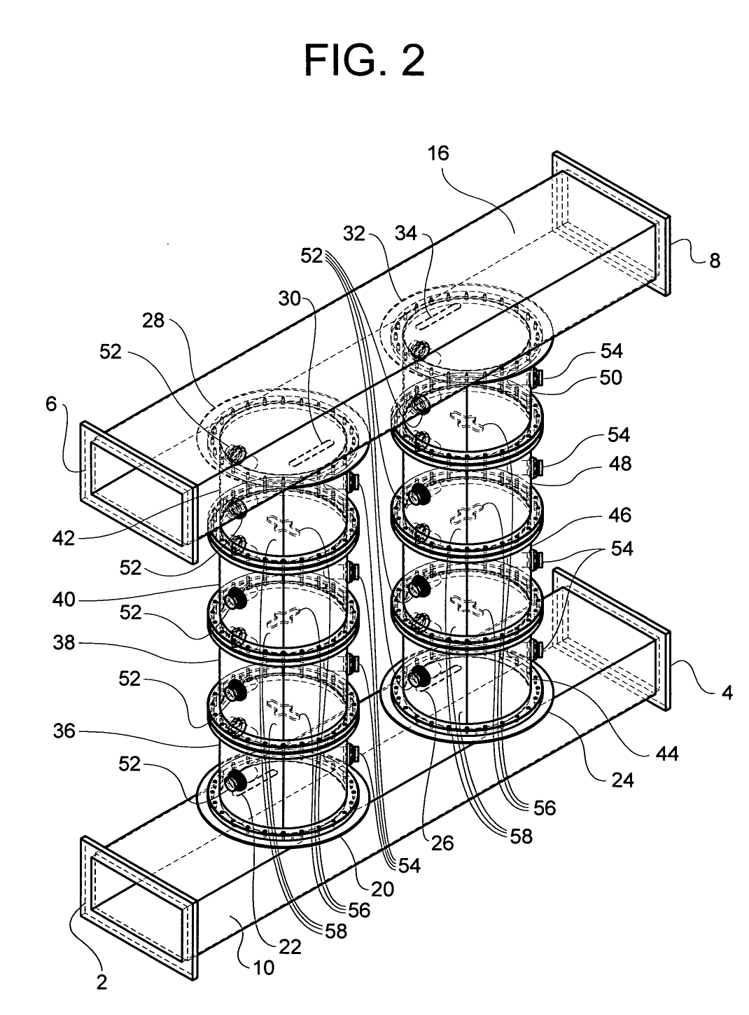

FIG. 2 is a phantom view of the DFC 1 of FIG. 1, showing the internal structure of the first elliptic filter 12 and the second elliptic filter 14. Here, it may be seen that the entry portals to the first elliptic filter 12 and the second elliptic filter 14 use a first baffle 20, closest to first flange 2, with a first iris 22; a second baffle 24, closest to second flange 4, with a second iris 26; a third baffle 28, closest to third flange 6, with a third iris 30, and a fourth baffle 32, closest to fourth flange 8, with a fourth iris 34. In the preferred embodiment, the apertures 22, 26, 30, and 34 in the four baffles 20, 24, 28, and 32, respectively, may be dimensionally equal to each other in their longitudinal and their transverse dimensions as well as their radii. The baffles 20, 24, 28, and 32 likewise may preferably be the same as each other in such material properties as thickness, coatings, method of attachment, and surface treatment, and in such physical properties as surface conductivity, surface finish, hardness, and the like.

In the preferred embodiment, shown in FIG. 2, the first and second input irises 22 and 26, respectively, admit RF in proper phase orientation to sustain propagation, while first and second output irises 30 and 34, respectively, couple the filtered signals into the output portal waveguide 16. The dimensions of the stacked, iris-coupled circular cavities 36, 38, 40, and 42 that comprise the first filter 12 and the equivalent iris-coupled circular cavities 44, 46, 48, and 50 that comprise the second filter 14 are chosen, in the case of the preferred embodiment, to realize elliptic filter coupling coefficients.

The slot iris inputs 22 and 26 are oriented parallel to the propagation axis of the input waveguide 10 and sized with a length appropriate to obtain the necessary elliptic coupling coefficient, thereby admitting the frequency of interest in the magnitude desired. Slot width and proportional distance from the centerline of the waveguide determine energy coupling. With the irises spaced three quarters of a wavelength of the center frequency apart in the preferred embodiment, each of the irises admits half of the energy but separated by 270 degrees. The equivalent slot iris outputs 30 and 34 are symmetric with the inputs 22 and 26 in spacing and dimensions, but placed on opposite sides of the midline of the output waveguide 16 to couple in opposite phase, effectively adding another 180 degrees to the phase shift of the system, so that the in-phase signal entering at flange 4 emits at port 6 while port 8 is isolated with respect thereto. RF propagating through the circular cavities 36-50 is polarized linearly, not circularly; thus, the RF may be tuned using orthogonal tuning probes 52 and the RF coupling may be controlled using probes inserted at probe ports 54, which may be located as indicated or plus or minus 90 degrees from where shown.

In the preferred embodiment, the irises 56 may comprise cutouts in separate plates 58 stacked and bolted together with cylindrical sections that together form the indicated structure. This configuration may be preferable in simplifying assembly and rework. Other assembly methods, depending on the materials used, may include brazing, soldering, bolting, affixing with conductive adhesives, building up from laminations, etching away from a whole, molding, extruding, and the like. The partitions may form an integral part of the elliptic filter section 12 or 14 with which they form an indissoluble unit. The conductive surface finishes of the RF filter sections may be intrinsic to the materials from which the filter elements are made, or may be applied by laminating, plating, electro deposition, painting, sputtering, or a combination including these and other methods.

Each inter-cavity iris plate 58 contains at least a single slot 56 that alternates orthogonal orientation for Chebyschev applications, implying a single coupling between each two filter cavities. For elliptic filter applications, some or all of the inter-cavity cylindrical iris plates 58 may contain dual, perpendicular slots of differing lengths, implying forward coupling and a reverse coupling that may control the reject zero location and attenuation value.

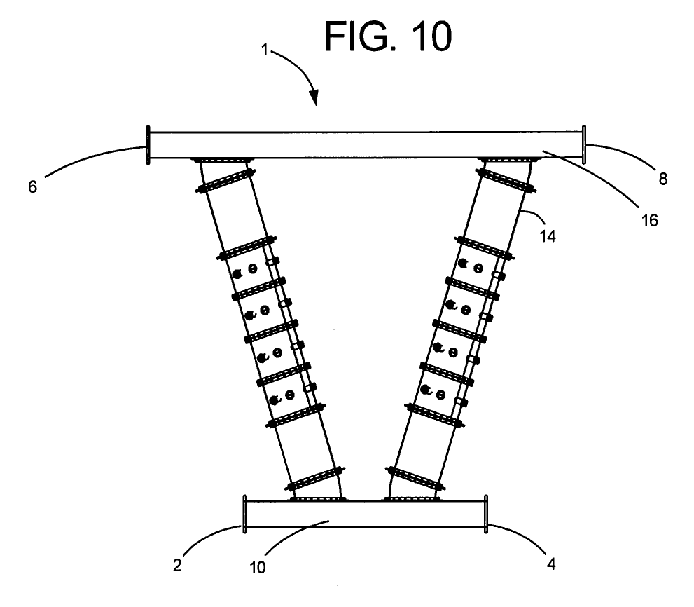

The cylindrical waveguide sections used in the structure of the filters in the preferred DFC embodiment may be compatible with implementation of an elliptic filter, the mathematics for which was derived by Darlington circa 1934. Alternative filter coefficients, such as Chebyschev and Butterworth, can be realized with or without the use of cylindrical waveguide filter sections. The selection of filter coefficients and the hardware technology to implement them is a function of system requirements and tradeoffs that may involve consideration of insertion loss, complexity, dollar cost, and size. The size of each filter section, for example, is a function of channel center frequency, and may thus be unique to each channel for which a filter is manufactured. A similar filter may use rectangular filter input and output sections feeding into the circular sections shown, or may be comprised entirely of cylindrical sections, as shown in FIGS. 6-10.

Ultra-high frequency (UHF) commercial television broadcasting may be considered as an application example. In developing DFCs for this use, individual broadcast channels may require DFCs comprised of filters with unique coefficients, which are proportional to the center frequency of each broadcast channel. The reasons for this need for channel-by-channel uniqueness include the condition that the broadcast TV channels in a given market (e.g., North America, the European Union, etc.) normally all have the same bandwidth, which is expressed as a constant value in megahertz, not as a percentage of center frequency. This dictates that the tuning for each cavity may be different for each of fifty or more broadcast channels. Consequently, each DFC preferably has a unique set of physical dimensions to achieve the filter characteristics intended for a particular broadcast channel frequency and passband. In the parts of the UHF band over which different cross-sectional sizes of waveguide may be used substantially interchangeably, moreover, the same DFC may be realized with different fittings to meet the requirements of different users; this adds still more hardware sizes to the range of possible implementations.

In applying the DFC 1 of FIG. 1 to any frequency band, whether UHF TV broadcast or otherwise, overall physical dimensions are determined by the chosen frequency band; the dimensions of the cavities determine the tuning bandwidth and details of in-band flatness and out-of-band rejection; and the number of cavities in the DFC contributes to determination of the skirt steepness, or sharpness of transition between in-band and out-of-band. This observation adds still another dimension to the range of hardware sizes and configurations.

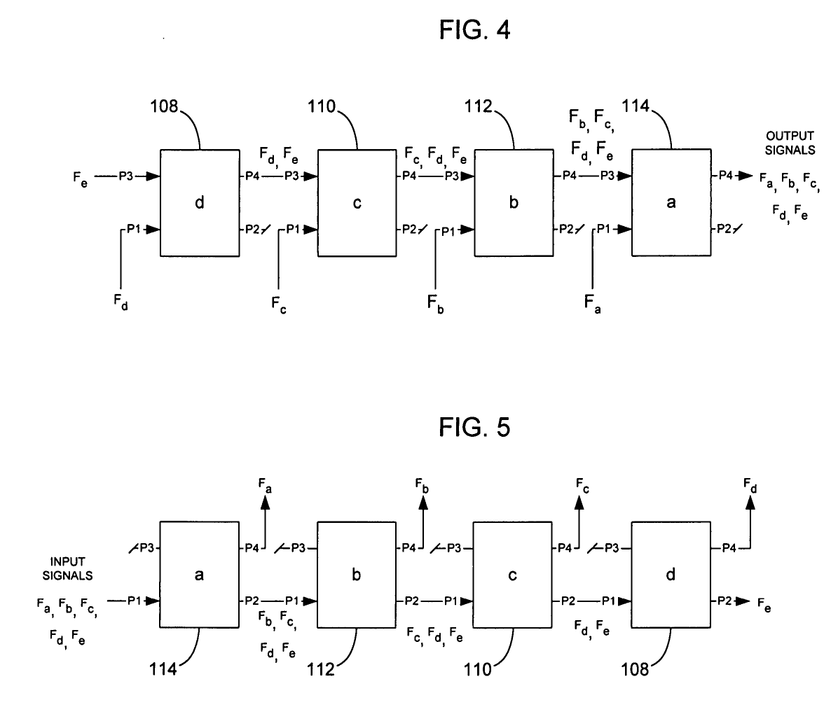

FIG. 4 shows a cascaded set of the DFC schematic blocks 88 from FIG. 3 fed by multiple frequencies to form a combiner. This circuit can be used for several purposes, including, for example, to put high-power RF signals at several frequencies into a single waveguide so that the signals can be sent from a transmitter complex to the top of a tower where the signals can in one embodiment be broadcast together using a broadband antenna. For simplicity, all equivalent ports in the filter sections in this example use the same labels.

In FIG. 4, the signals Fₐ through Fₑ are fed into DFCs 88 represented by single schematic blocks. The center frequencies of the signals are indicated by their subscripts. The center frequencies of the DFCs 88, which are the same as those of the signals, are indicated by single letters on their respective schematic blocks.

In keeping with the foregoing description, when Fₑ is applied to port P3 of schematic block d, the signal is rejected and passes out through port P4. F_{d}, when applied to port P1 of block d, is admitted rather than rejected. This causes F_{d} to also pass out through port P4. This result shows that the DFC schematic blocks as described can perform a combiner function. F_{c} is admitted by block c and thus is available to exit block c at port P4; F_{d} and Fₑ, admitted at P3 of block c, but rejected by block c, are emitted at port P4 whence they are fed into P3 of block b. When the combined Fₑ, F_{d}, and F_{c} are introduced to block b at port P3, they are rejected and thus appear at port P4 along with F_{b}, introduced at port P1 of block b. Fₐ is applied to block a in the same fashion to form the final signal combining all five channels.

FIG. 6 shows the FIG. 5 system operated in reverse to separate the frequencies previously combined. This configuration can be used, for example, mounted atop a tower, to extract the single, full-power channel for each of an array of narrow-band antennas from the combined signal that was formed at the transmitters using the system of FIG. 5.

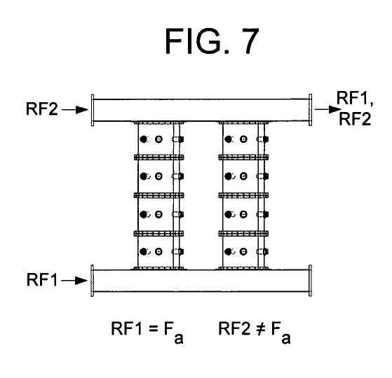

FIG. 7 shows a highly simplified single DFC 1 to identify the connectivity to be used in the following three figures, where the first flange 2, the second flange 4, the third flange 6, and the fourth flange 8 use the same references as previously.

FIG. 7 shows a single DFC fed by one UHF TV broadcast channel signal RF1 at the first flange and a second UHF TV broadcast channel signal RF2 at the third flange. Where the center frequency of RF1 is Fₐ, which is the center frequency of the DFC, and the center frequency of RF2 is outside the Fₐ passband, then both RF1 and RF2 pass out through the fourth flange, which repeats the combiner case described above.

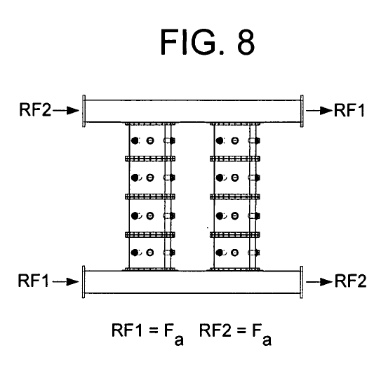

FIG. 8 shows a configuration similar to that of FIG. 7, that is, RF1 is injected at the first flange and RF2 is injected at the third flange, but in this case both signals have center frequencies at Fₐ. Now both signals are admitted into both the first and the second filters, but from opposite ends, so they cross and are emitted at opposite ports. Apparatus of this type can exhibit isolation on the order of 25 dB, so the crossing and separate emission discussed can be demonstrated in practice.

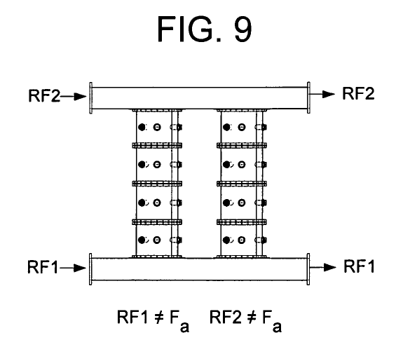

FIG. 9 shows a configuration also similar to that of FIG. 7, except that now neither RF1 nor RF2 is at Fₐ. This time both signals are rejected, each proceeds along its respective input waveguide, and each is emitted from the output port in line with its input, namely RF1 exits at P2 and RF2 exits at P4.

Other permutations of inputs and outputs in addition to those shown in FIGS. 8-10 can be configured to support, for example, combiner inputs and separated outputs. P3 in all the above cases of FIG. 4 are wide band inputs. When feeding a signal into a wideband input it is customary to use an additional module to supplement the isolation of the two combined inputs. Accordingly, filters, basic combiners, and basic separators, all of which may be used alone or cascaded, can be arranged.

The signal conditioning described herein is suitable for functions other than broadcast. Research applications such as high-energy physics, for example, can use high-purity, high-energy RF signals in pulse or continuous form, of which the DFC embodiments described herein are capable.

The many features and advantages of the invention are apparent from the detailed specification, and thus, it is intended by the appended claims to cover all such features and advantages of the invention that fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, that fall within the scope of the invention.

1. A waveguide directional filter and/or combiner for filtering and combining radio frequency signals (RF), comprising:
a first rectangular waveguide section;
a first elliptic filter section, ported to said first rectangular waveguide section at a substantially perpendicular angle thereto, with a common electrical-signal axis thereto;
a second elliptic filter section, ported to said first rectangular waveguide section at a substantially perpendicular angle thereto and substantially parallel to said first elliptic filter section, with an electrical-signal axis parallel to that of said first elliptic filter section; and
a second rectangular waveguide section affixed to, ported to, and terminating said first and second elliptic filter sections.

2. The waveguide directional filter and/or combiner of claim 1, further comprising:
a first rectangular waveguide flange affixed to and terminating said first rectangular waveguide section on the end thereof proximal to said first waveguide filter section;
a second rectangular waveguide flange, affixed to and terminating said first rectangular waveguide on the end thereof proximal to said second waveguide filter section;
a third rectangular waveguide flange, affixed to and terminating said second rectangular waveguide section on the end thereof proximal to said first waveguide filter section; and
a fourth rectangular waveguide flange, affixed to and terminating said second rectangular waveguide section on the end thereof proximal to said second waveguide filter section.

3. The waveguide directional filter and/or combiner of claim 1, wherein said first rectangular waveguide section accepts RF for propagation through the waveguide directional filter and/or combiner.

4. The waveguide directional filter and/or combiner of claim 1, wherein said first elliptic filter section accepts, from said first rectangular waveguide, in-band RF aligned with a TE₁₀ propagation axis of said waveguide, and rejects both out-of-phase in-band RF and all out-of-band RF.

5. The waveguide directional filter and/or combiner of claim 1, wherein said second elliptic filter section is so spaced from said first elliptic filter section as to accept in-band RF out of phase with respect to the in-band RF accepted by said first elliptic filter section.

6. The waveguide directional filter and/or combiner of claim 5, wherein said second elliptic filter section rejects out-of-band RF from said first rectangular waveguide.

7. The waveguide directional filter and/or combiner of claim 2, wherein said second rectangular waveguide flange forms a portal out which RF rejected by said first elliptic filter section and said second elliptic filter section may pass.

8. The waveguide directional filter and/or combiner of claim 1, wherein said second rectangular waveguide section forms a pathway along which RF from said first and second elliptic filter sections may propagate.

9. The waveguide directional filter and/or combiner of claim 2, wherein said second rectangular waveguide section forms a pathway along which RF from said third rectangular waveguide flange may propagate.

10. The waveguide directional filter and/or combiner of claim 2, wherein said fourth rectangular waveguide flange forms a portal out which RF from said first rectangular waveguide flange, propagated through said first elliptic filter section and said second elliptic filter section, and RF from said third rectangular waveguide flange, rejected by said first elliptic filter section and said second elliptic filter section, may pass.

11. The waveguide directional filter and/or combiner of claim 1, wherein said first elliptic filter section further comprises:
a first first-filter resonator receiving RF from said first rectangular waveguide section and passing the received RF to the next first-filter resonator;
a plurality of successive first-filter resonators, each receiving RF from the previous first-filter resonator and passing the received RF to the next first-filter resonator; and
a final first-filter resonator, receiving RF from the previous first-filter resonator and passing the received RF to the second rectangular waveguide section.

12. The waveguide directional filter and/or combiner of claim 11, wherein said first first-filter resonator further comprises:
a first first-filter resonator input baffle restricting propagation of RF from said first rectangular waveguide section into said first waveguide filter section;
a first first-filter resonator input iris in said first first-filter resonator input baffle, permitting in-band RF energy in the frequency range of the waveguide directional filter and/or combiner, and oriented in the direction permitted by said first first-filter resonator input iris, to propagate into said first waveguide filter section;
a first first-filter resonator output baffle; and
a first first-filter resonator output iris in said first first-filter resonator output baffle, interacting with said first first-filter resonator input baffle, said first first-filter resonator input iris, a set of first first-filter resonator tuning probes, and a cavity structure of said first waveguide filter section to form a first first-filter resonator that sustains propagation of correctly oriented in-band RF, coupling in-band RF out of said first first-filter resonator and into a successive first-filter resonator.

13. The waveguide directional filter and/or combiner of claim 11, wherein each of said plurality of successive first-filter resonators further comprises:
a successive first-filter resonator input iris, coupling correctly oriented in-band RF from a previous first-filter resonator into said successive first-filter resonator, which input iris is also the output iris from the immediately preceding resonator; and
a successive first-filter resonator output iris, interacting with said successive first-filter resonator input iris, a set of successive first-filter resonator tuning probes, and a cavity structure of said successive first-filter, resonator to form a successive first-filter resonator that sustains propagation of correctly oriented in-band RF, thereby coupling the in-band R° F out of the immediately preceding first-filter resonator and into the next succeeding first-filter resonator.

14. The waveguide directional filter and/or combiner of claim 11, wherein the final first-filter resonator further comprises:
a final first-filter resonator input iris coupling correctly oriented in-band RF from the immediately preceding first-filter resonator into said final first-filter resonator, which iris is also the resonator output iris from the immediately preceding first-filter resonator; and
a final first-filter resonator output iris in said final first-filter resonator baffle, interacting with said final first-filter resonator input iris, a set of final first-filter resonator tuning probes, and a cavity structure of said final first filter resonator to form a final first-filter resonator that couples correctly oriented in-band RF into said second rectangular waveguide section.

15. The waveguide directional filter and/or combiner of claim 1, wherein said second elliptic filter section further comprises:
a first second-filter resonator receiving RF from said first rectangular waveguide section and passing the received RF to the next second-filter resonator;
a plurality of successive second-filter resonators, each receiving RF from the previous second-filter resonator and passing the received RF to the next second-filter resonator; and
a final second-filter resonator, receiving RF from the previous second-filter resonator and passing the received RF to the second rectangular waveguide section.

16. The waveguide directional filter and/or combiner of claim 15, wherein said second resonator further comprises:
a first second-filter resonator input baffle restricting propagation of RF from said first rectangular waveguide section into said second waveguide filter section;
a first second-filter resonator input iris in said first second-filter resonator input baffle, permitting in-band RF energy in the frequency range of the waveguide directional filter and/or combiner, and oriented in the direction permitted by said first second-filter resonator input iris, to propagate into said second waveguide filter section;
a first second-filter resonator output baffle; and
a first second-filter resonator output iris in said first second-filter resonator output baffle, interacting with said first second-filter resonator input baffle, said first second-filter resonator input iris, a set of first second-filter resonator tuning probes, and a cavity structure of said second waveguide filter section to form a first second-filter resonator that sustains propagation of correctly oriented in-band RF, coupling in-band RF out of said first second-filter resonator and into a subsequent second-filter resonator.

17. The waveguide directional filter and/or combiner of claim 15, wherein each of said plurality of successive second-filter resonators further comprises:
a successive second-filter resonator input iris, coupling correctly oriented in-band RF from a previous second-filter resonator into said successive second-filter resonator, which iris is also the output iris from the immediately preceding resonator; and
a successive second-filter resonator output iris, interacting with said successive second-filter resonator input iris, a set of successive second-filter resonator tuning probes, and a cavity structure of said successive second filter resonator to form a successive second-filter resonator that sustains propagation of correctly oriented in-band RF, thereby coupling the in-band RF out of the immediately preceding second-filter resonator and into the next succeeding second-filter resonator.

18. The waveguide directional filter and/or combiner of claim 15, wherein the final second-filter resonator further comprises:
a final second-filter resonator input iris coupling correctly oriented in-band RF from the immediately preceding second-filter resonator into said final second-filter resonator, which iris is also the resonator output iris from the immediately preceding second-filter resonator; and
a final second-filter resonator output iris in said final second-filter resonator baffle, interacting with said final second-filter resonator input iris, a set of final second-filter resonator tuning probes, and a cavity structure of said final second-filter resonator to form a final second-filter resonator that couples correctly oriented in-band RF into said second rectangular waveguide section.

19. The waveguide directional filter and/or combiner of claim 1, wherein said directional filter and/or combiner may function as a combiner, that is, said directional filter and/or combiner may be fed with two RF input signals on two of its ports assigned as input ports, of which input signals one is an in-band RF signal and the other an out-of-band RF signal of such frequency as to be carried with low attenuation by the waveguides comprising said directional filter and/or combiner, as a consequence of which both the in-band and the out-of-band RF signals will be present at a single output port of said directional filter and/or combiner.

20. The waveguide directional filter and/or combiner of claim 1, wherein said directional filter and/or combiner may function as a separator, that is, said directional filter and/or combiner may be fed with an RF input signal, itself comprised of a plurality of RF signals, on one of its ports assigned as an input port, of which component RF input signals one is an in-band RF signal with respect to said directional filter and/or combiner and the remainder out-of-band RF signals of frequencies carried with low attenuation by the waveguides comprising said directional filter and/or combiner, as a consequence of which the in-band RF signal will be present at one output port of said directional filter and/or combiner and the out-of-band RF signals will be present at a second output port of said directional filter and/or combiner.

21. An apparatus for filtering RF signals, comprising:
first means for guiding an RF broadcast signal along a path with a conductive boundary, along which path the signal can propagate;
first means for directing a component of the RF broadcast signal within a specific frequency range and a specific phase orientation along a path at right angles to the first conductively-bound path, wherein the in-band, rolloff, and out-of-band characteristics of the first means for directing correspond to those of an elliptic filter;
second means for guiding the remnant RF broadcast signal further along the initial path;
second means for directing an RF broadcast signal component at the same frequency as but out of phase with respect to the RF broadcast signal component directed by the first means for directing, wherein said second means for directing directs the RF signal component that was out of phase with respect to and unable to be directed by said first means for directing, and wherein the in-band, rolloff, and out-of-band characteristics of the second means for directing correspond to those of an elliptic filter;
third means for guiding the out-of-band energy of the RF broadcast signal along a further path exiting the apparatus;
means for rejoining the specific RF broadcast signal components back together in the their original phase relationship; and
fourth means for guiding the rejoined RF broadcast signal components along a further path out of the apparatus.

22. A method for filtering, combining, and separating RF signals, comprising the following steps:
admitting an RF broadcast signal into a first portal waveguide;
propagating the RF signal along the first portal waveguide;
admitting any in-band RF signal energy at a first phase angle from the RF broadcast signal into a first elliptic filter;
further propagating the RF signal along a continuation of the first portal waveguide for a distance approximating an odd number of quarter wavelengths of the in-band component of the RF signal;
admitting from the RF broadcast signal into a second elliptic filter any in-band RF signal energy out of phase with respect to the RF signal energy admitted into the first filter;
passing any RF broadcast signal energy admitted into neither filter out the end of the first portal waveguide;
collecting the in-band RF signal energy passed through either elliptic filter into a second portal waveguide with a geometry that restores the original phase relation of the in-band RF signal components; and
passing the recombined in-band RF signal energy out of the end of the second portal waveguide.
